(19) United States
(12) Patent Application Publication
(10) Pub. No.: US 2026/0340862 A1
(43) Pub. Date: Oct. 29, 2026

(54) INFORMATION PROCESSING APPARATUS, MACHINE LEARNING MODEL, INFORMATION PROCESSING METHOD, AND STORAGE MEDIUM

(71) Applicant: CANON KABUSHIKI KAISHA, Tokyo (JP)

(72) Inventor: Takamasa Tsunoda, Tokyo (JP)

(21) Appl. No.: 19/731,568

(22) Filed: Jul. 6, 2026

Related U.S. Application Data
(63) Continuation of application No. 17/902,076, filed on Sep. 2, 2022.

(30) Foreign Application Priority Data
Sep. 6, 2021 (JP) 2021-145065

(51) Int. Cl. G06T 7/70; G06T 7/20; G06V 10/44; G06V 10/764

(52) U.S. Cl. CPC G06T 7/70; G06T 7/20; G06V 10/44; G06V 10/764; G06T 2207/10028; G06T 2207/20081; G06T 2207/20084; G06V 2201/07

(57) ABSTRACT

There is provided with an information processing apparatus including a machine learning model configured to perform a recognition process on a recognition target in a captured image, based on pixel information of the captured image, and information about the captured image in addition to the pixel information. An inputting unit inputs the pixel information to a first portion of the machine learning model. A processing unit performs the recognition process by inputting correction information obtained by correcting an output of the first portion of the machine learning model by using the information about the captured image, to a second portion of the machine learning model, which follows the first portion.

### CROSS REFERENCE TO RELATED APPLICATIONS

This application is a continuation of U.S. patent application Ser. No. 17/902,076, filed on Sep. 2, 2022, which claims the benefit of and priority to Japanese Patent Application No. 2021-145065, filed Sep. 6, 2021, each of which is hereby incorporated by reference herein in their entirety.

### BACKGROUND OF THE INVENTION

### Field of the Invention

The present invention relates to an information processing apparatus, a machine learning model, an information processing method, and a storage medium.

### Description of the Related Art

Many CNNs for performing image recognition tasks such as image classification, object detection, and semantic segmentation have been proposed. Jonathan Long, Evan Shelhamer, and Trevor Darrell, “Fully Convolutional Network for Semantic Segmentation” and Olaf Ronneberger, Philipp Fischer, and Thomas Brox, “U-Net: Convolutional Networks for Biomedical Image Segmentation” disclose CNNs for performing semantic segmentation. In these CNNs, a feature amount of an input image is extracted by a convolutional layer pre-pooling layer, bilinear interpolation and up sampling by a deconvolutional layer are performed, and a region category map having resolution equal to that of the input image is output.

Also, a CNN that performs a recognition process by using an image and information other than the image has been proposed. Caner Hazirbas, Lingni Ma, Csaba Domokos, and Daniel Cremers, “FuseNet: Incorporating Depth into Semantic Segmentation via Fusion-based CNN Architecture” discloses a CNN that performs semantic segmentation by receiving a depth map in addition to an RGB image. Furthermore, Karen Simonyan, and Andrew Zisserman, “Two-Stream Convolutional Networks for Action Recognition in Videos” discloses a CNN that performs action recognition by using an optical flow image having a plurality of frames in addition to an RGB image.

### SUMMARY OF THE INVENTION

According to one embodiment of the present disclosure, an information processing apparatus including a machine learning model configured to perform a recognition process on a recognition target in a captured image, based on pixel information of the captured image, and information about the captured image in addition to the pixel information, comprises: an inputting unit configured to input the pixel information to a first portion of the machine learning model; and a processing unit configured to perform the recognition process by inputting correction information obtained by correcting an output of the first portion of the machine learning model by using the information about the captured image, to a second portion of the machine learning model, which follows the first portion.

According to another embodiment of the present disclosure, an information processing apparatus for performing learning of a machine learning model configured to perform a recognition process on a recognition target in a captured image, based on pixel information of the captured image, and information about the captured image in addition to the pixel information, comprises: an acquisition unit configured to acquire second ground truth data indicating ground truth of an output of the machine learning model with respect to the captured image; a formation unit configured to form first ground truth data indicating ground truth of correction information obtained by correcting an output of a first portion of the machine learning model that receives the pixel information by using the information about the captured image; and a learning unit configured to perform learning of the machine learning model based on an error between the correction information and the first ground truth data, and an error between the second ground truth data and an output when the correction information is input to a second portion of the machine learning model, which follows the first portion.

According to still another embodiment of the present disclosure, a machine learning model, which has been trained, configured to perform a recognition process on a recognition target in a captured image, based on pixel information of the captured image, and information about the captured image in addition to the pixel information, consists of: a first portion, on which learning is performed so as to extract and output characteristic of the pixel information using the pixel information as input; and a second portion which follows the first portion, on which learning is performed so as to perform the recognition process using correction information obtained by correcting an output of the first portion by using the information about the captured image as input.

According to yet another embodiment of the present disclosure, an information method which performs a process according to an information processing apparatus including a machine learning model configured to perform a recognition process on a recognition target in a captured image, based on pixel information of the captured image, and information about the captured image in addition to the pixel information, comprises: inputting the pixel information to a first portion of the machine learning model; and performing the recognition process by inputting correction information obtained by correcting an output of the first portion of the machine learning model by using the information about the captured image, to a second portion of the machine learning model, which follows the first portion.

According to yet still another embodiment of the present disclosure, an information processing method for performing learning of a machine learning model configured to perform a recognition process on a recognition target in a captured image, based on pixel information of the captured image, and information about the captured image in addition to the pixel information, comprises: acquiring second ground truth data indicating ground truth of an output of the machine learning model with respect to the captured image; forming first ground truth data indicating ground truth of correction information obtained by correcting an output of a first portion of the machine learning model that receives the pixel information by using the information about the captured image; and performing learning of the machine learning model based on an error between the correction information and the first ground truth data, and an error between the second ground truth data and an output when the correction information is input to a second portion of the machine learning model, which follows the first portion.

A non-transitory computer-readable storage medium storing a program that, when executed by a computer, causes the computer to perform an information processing method which performs a process according to an information processing apparatus including a machine learning model configured to perform a recognition process on a recognition target in a captured image, based on pixel information of the captured image, and information about the captured image in addition to the pixel information, the method comprising: inputting the pixel information to a first portion of the machine learning model; and performing the recognition process by inputting correction information obtained by correcting an output of the first portion of the machine learning model by using the information about the captured image, to a second portion of the machine learning model, which follows the first portion.

Further features of the present invention will become apparent from the following description of exemplary embodiments (with reference to the attached drawings).

### BRIEF DESCRIPTION OF THE DRAWINGS

FIGS. 1A to 1C are views for explaining examples of an input image, GT, and an image recognition process according to the first embodiment;

FIG. 2 is a view for explaining an example of a learning mechanism of a CNN according to the first embodiment;

FIG. 3A is a view showing an example of the functional configuration of a recognition apparatus according to the first embodiment;

FIG. 3B is a view showing an example of the functional configuration of a learning apparatus;

FIG. 4A is a flowchart showing an example of processing to be performed by the recognition apparatus according to the first embodiment;

FIGS. 4B and 4C are flowcharts showing an example of processing in a learning process;

FIG. 5 is a view showing an example of the functional configuration of a learning apparatus according to the second embodiment;

FIG. 6A is a view for explaining an example of a learning mechanism of a CNN according to the third embodiment;

FIGS. 6B and 6C are views showing an example of a network that repetitively aggregates high-dimensional features into low-dimensional features;

FIG. 7 is a view showing an example of the functional configuration of a learning apparatus according to the third embodiment;

FIG. 8 is a view for explaining an example of a recognition process for a moving image according to the fourth embodiment;

FIG. 9 is a view showing an example of the functional configuration of a recognition apparatus according to the fourth embodiment;

FIG. 10 is a view showing an example of a recognition process including an allocation process according to the fourth embodiment; and

FIG. 11 is a view showing the hardware configuration of a computer according to the fifth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In the CNNs described by Caner Hazirbas and Karen Simonyan, maps different in modality are input in addition to an RGB image, so the network structure increases the calculation cost in many cases when compared to a case in which only an RGB image is input. In the method described by Caner Hazirbas, an input image is encoded by using two branches for respectively receiving an RGB image and a depth map, so the CNN branch for processing the depth map increases the calculation cost. In the method described by Karen Simonyan, different CNNs process two streams of a space and time, and the recognition results of the two streams are finally integrated. In this case, one frame of an optical flow image input to the time stream is changed into images of two channels by decomposing the vector field of the flow into two axes, that is, the X-axis direction and the Y-axis direction.

Each embodiment of the present invention provides an information processing apparatus for reducing the calculation cost of a machine learning model that performs a recognition task by receiving an image and information about the image.

### First Embodiment

A recognition apparatus 1000 and a learning apparatus 2000 as information processing apparatuses according to one embodiment recognize a recognition target in input data by using a machine learning model. In this embodiment, an image recognition process using semantic segmentation is performed by using a convolutional neural network (CNN) that receives a captured image and information about the captured image as input data. In this embodiment, the learning apparatus 2000 performs learning of the machine learning model, and the recognition apparatus 1000 performs a recognition process by using the learning result. The recognition apparatus and the learning apparatus can be installed in one apparatus, and can also be installed as different apparatuses.

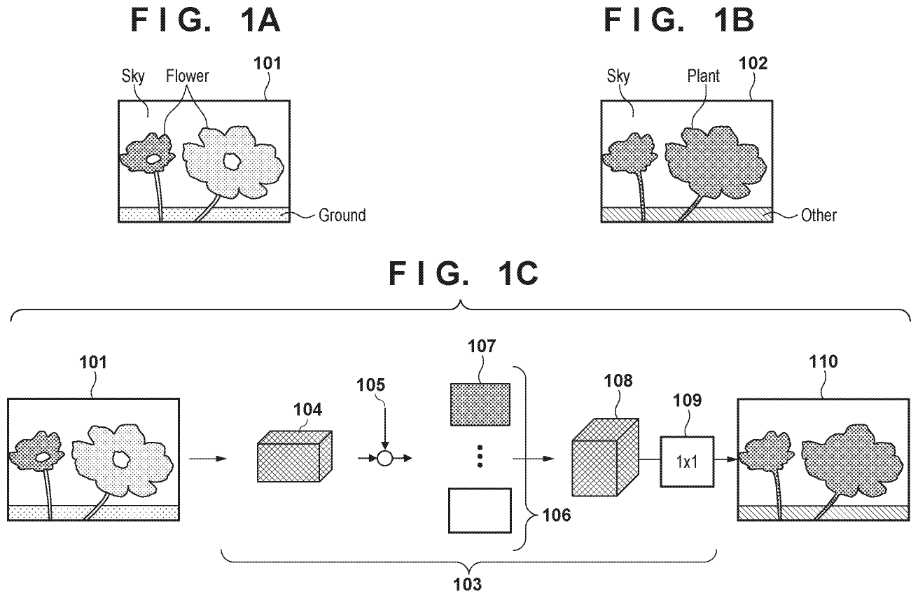

FIGS. 1A to 1C are schematic views for explaining the image recognition process to be performed by the recognition apparatus 1000. An input image 101 shown in FIG. 1A is an example of image data to be input to the recognition apparatus 1000 according to this embodiment. The input image 101 is an RGB image in this embodiment, but can also have a CMYK form or the like. That is, the form of the image such as the color space is not particularly limited as long as the image recognition process can be performed.

Also, in the recognition process to be performed by the recognition apparatus 1000 and the learning apparatus 2000 according to this embodiment, a subject in the captured image is classified into one of categories Plant, Sky, and Other. The input image 101 contains flowers (classified into Plant) in the center of the foreground, the sky (classified into Sky) in the background, and the ground (classified into Other). Since this is merely an example, so the recognition apparatus 1000 and the learning apparatus 2000 can perform classification into different categories, and different subjects can be arranged in the input image 101 and ground truth (GT) 102 to be described below.

The GT 102 shown in FIG. 1B is an example of the ground truth (GT) corresponding to the input image 101. In this embodiment as described above, a flower, the sky, and the ground are respectively associated with the categories Plant, Sky, and Other. Also, as shown in FIG. 1B, a region where a target object of each category exists in the GT 102 is given a label corresponding to the category. The label is information indicating a category to be given to each region. In each drawing, a label to be given as the result of classification (or given to ground truth data) is indicated by a color (halftone). In this embodiment, an image recognition task that segments a region in an input image into partial regions corresponding to specific categories as shown in the GT 102 is performed as semantic segmentation.

FIG. 1C shows an example of inputting/outputting of a CNN 103 included in the recognition apparatus 1000 according to this embodiment. A calculation mechanism of the CNN 103 according to this embodiment will be explained below.

The CNN 103 has a hierarchical structure in which a plurality of modules formed by layers that perform convolution, activation, pooling, normalization, and the like are connected. The CNN 103 receives the input image 101 and outputs an inference result 110 as the result of category classification in the image. As described by Jonathan Long or Olaf Ronneberger, the CNN 103 can output the inference result 110 by matching the sizes of intermediate features of low-order to high-order layers by up-sampling the intermediate feature of the high-order layer in accordance with the output size, and by using 1×1 convolution.

In this embodiment, the CNN 103 will be explained by dividing it into two portions, that is, a CNN 104 for performing front-stage processing, and a CNN 108 for performing rear-stage processing. Also, the CNN 103 includes an input terminal 105 for accepting input of side information. The side information according to this embodiment is information related to an image and having influence on pixel values of the image. The side information is input to an intermediate layer of the machine learning model (CNN 103) in addition to an input image.

By performing the image recognition task by receiving the side information as an input to the machine learning model in addition to an image, it is possible to obtain an output based on the information different from the appearance of the image as well. For example, the side information can be an image capturing parameter of an image capturing device for capturing an input image, and can also be a value calculated from an input image. As the side information, it is possible to use, for example, a white balance (WB) coefficient, a motion vector, Brightness value (Bv) as an evaluation value of automatic exposure, a subject distance from the image capturing device, an aperture value, or a focal length. An example using Bv as the side information will be explained below, but the present invention is not limited to this, and arbitrary side information can be used as long as the information has influence on pixel values of an image. The side information can be any of a scalar value, a one-dimensional vector, and a two-dimensional vector, and information having an arbitrary form can be used as long as the information can be processed. In this embodiment, learning of the CNN 103 is performed such that correction information obtained by correcting the output from the intermediate layer of the CNN 103 by the side information is output as a side map obtained by mapping the side information. A detailed explanation of the side map and side map GT as GT of the side map will be described later.

In this embodiment, an output from the CNN 104, that is, an output from the intermediate layer of the CNN 103 is corrected by using the side information. An intermediate layer 106 is an example of the output of the intermediate layer thus corrected. The recognition apparatus 1000 as the information processing apparatus according to this embodiment adds an activation layer to an arbitrary channel of the intermediate layer 106, and acquires GT for an output from the activation layer. Then, the recognition apparatus 1000 calculates a loss of the output from the activation layer and the GT, and performs learning of the CNN so that the output from the intermediate layer 106 corresponds to the GT. A channel 107 is one of output channels of the intermediate layer 106, and is a channel for estimating the side map. The intermediate layer 106 has a plurality of channels at the same resolution as that of the input obtained through up sampling, but this resolution can also be different from that of the input image.

Outputs from channels including the channel 107 are input to the CNN 108. An output layer 109 outputs the inference result 110 by 1×1 convolution and the activation layer. In this embodiment, the inference result 110 has three normalized channels having a height and a width equal to those of the input image 101, and respectively corresponding to the likelihoods of categories Plant, Sky, and Other. That is, in these three channels, the sum of the likelihoods of categories Plant, Sky, and Other in the same position is 1.0, and each value is a real number in [0, 1]. The softmax function can be used in a final activation layer of the output layer 109. Also, an arbitrary activation layer normally used in the network configuration of the CNN can be used as the activation layer of the CNN 103. For example, it is possible to use a ReLU (Rectified Linear Unit, a ramp function) or a Leaky ReLU.

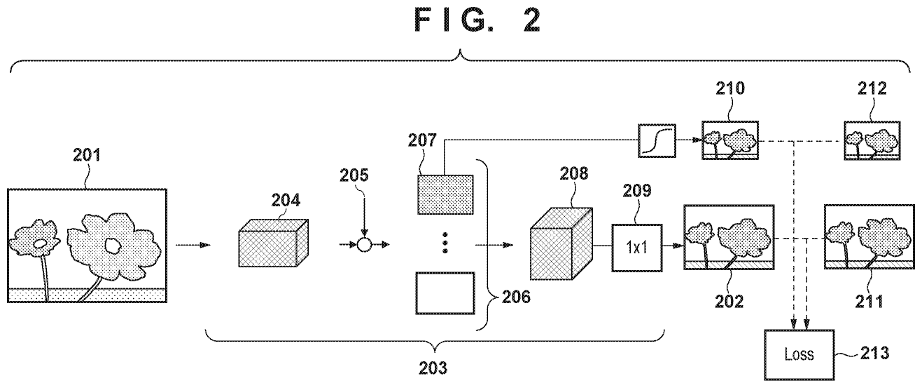

FIG. 2 is a schematic view for explaining a learning mechanism of the learning apparatus as the information processing apparatus according to this embodiment. An input image 201 is similar to the input image 101, and input to a CNN 203. The CNN 203 has a configuration similar to that of the CNN 103, and includes a CNN 204 for performing front-stage processing, an input terminal 205 for accepting input of the side information, an intermediate layer 206, a CNN 208 for performing rear-stage processing, and an output layer 209.

An output 202 is an example of the output result of the CNN 203, and is the result of category classification with respect to the input image 201, like the inference result 110 shown in FIG. 1. GT 211 is ground truth data corresponding to the input image, like the GT102 shown in FIG. 1. An output 210 is an example of the output from the intermediate layer 206, which is related to a response of one channel of the intermediate layer 206, and obtained via a predetermined activation layer. The output 210 is the output from a channel having learned beforehand to estimate a side map, and GT 212 is GT of the side map corresponding to the output 210. The learning apparatus 2000 calculates a loss 213 of the outputs 202 and 210 from the ground truth data (the GTs 211 and 212). In this embodiment, the loss 213 is calculated by using cross-entropy.

In one updating process of learning, error back propagation is performed based on the loss calculated by a loss function, update values of the weight and bias of each layer are calculated, and update is performed. In this example, the GT 212 is obtained for the response of one channel of the intermediate layer 206, and the loss is calculated, thereby performing learning of one channel of the intermediate layer. This learning process is not limited to one channel, and learning may also be performed by preparing GTs corresponding to a plurality of channels of the intermediate layer 206.

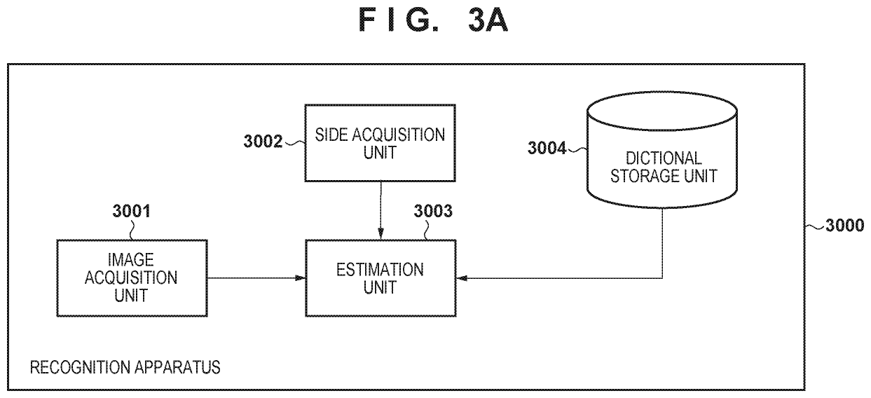

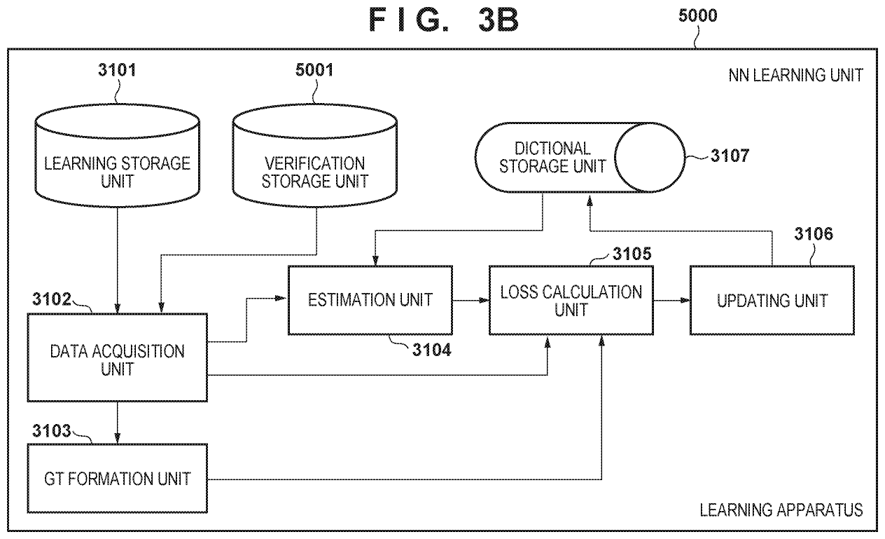

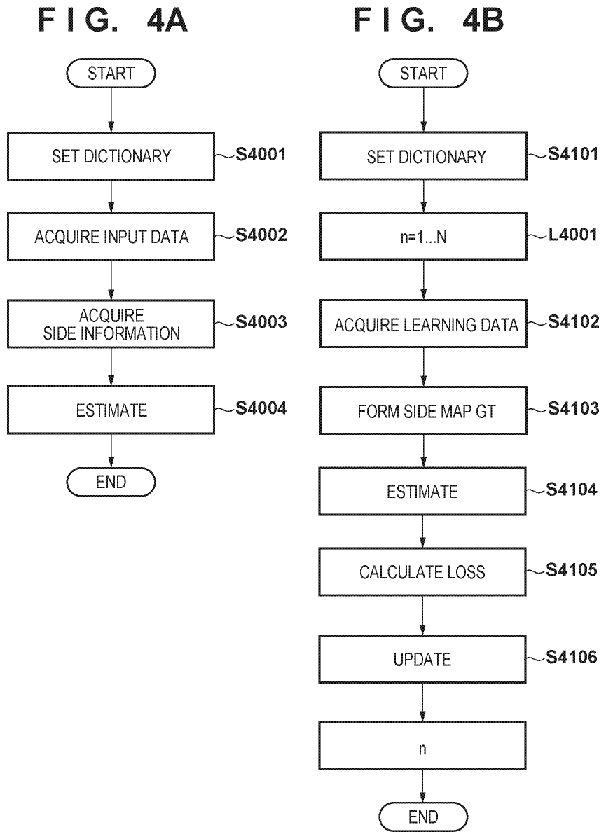

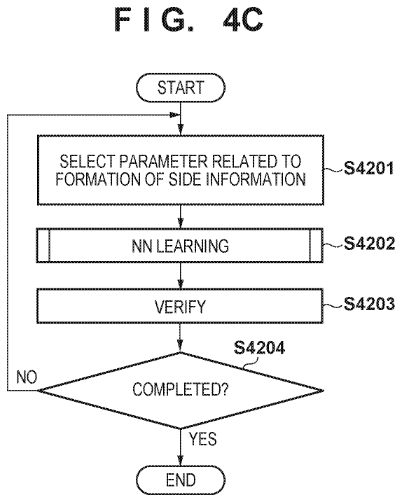

FIG. 3A is a block diagram showing an example of the functional configuration of the recognition apparatus as the information processing apparatus according to this embodiment. A recognition apparatus 3000 performs processing at the runtime of the CNN 103 described above, and includes an image acquisition unit 3001, a side acquisition unit 3002, an estimation unit 3003, and a dictionary storage unit 3004 for the runtime processing. FIG. 3B is a block diagram showing an example of the functional configuration of the learning apparatus as the information processing apparatus of this embodiment. A learning apparatus 3100 performs processing in the learning mechanism shown in FIG. 2. The learning apparatus 3100 includes a learning storage unit 3101, a data acquisition unit 3102, a GT formation unit 3103, an estimation unit 3104, a loss calculation unit 3105, an updating unit 3106, and a dictionary storage unit 3107, as storage units for storing data. The function of each block will be explained below with reference to flowcharts shown in FIGS. 4A to 4C.

FIGS. 4A to 4C are flowcharts showing examples of processing to be performed by the recognition apparatus 3000 and the learning apparatus 3100 according to this embodiment. FIG. 4A shows an example of processing to be executed by the recognition apparatus 3000 at the runtime of the CNN 103 described above. In S4001, the dictionary storage unit 3004 sets a dictionary to be used by the estimation unit 3003. The following explanation will be made by assuming that the dictionary indicates parameters such as the weight and the bias to be used in each layer of the CNN. That is, in S4001, the weight and bias of each layer of the convolutional neural network to be used by the estimation unit 3003 are loaded.

In S4002, the image acquisition unit 3001 acquires an image (that is, an input image 1001) as a target of the recognition process. The image acquisition unit 3001 resizes the input image 1001 so that the input image 1001 matches the input size of the CNN 103, and performs pre-processing of each pixel if necessary. For example, as this pre-processing of each pixel, the image acquisition unit 3001 can perform a process of reducing the average RGB value of a pre-acquired given image set from the RGB channel of each pixel of the input image, and can also perform arbitrary different processes in accordance with environments. The explanation will be made by assuming that image data converted by the pre-processing as described above is also called an input image.

In S4003, the side acquisition unit 3002 acquires the side information to be input to the intermediate layer of the CNN. The side information according to this embodiment is Bv as described earlier, and is the scalar value in this case. Bv is information calculated based on information of the brightness detected by a photosensor in a camera, and usable in the camera. In the following explanation, outputs corrected by using the side information will collectively called a Bv map.

In S4004, the estimation unit 3003 recognizes a recognition target in the input data by using a machine learning model having a hierarchical structure including a plurality of layers. In this embodiment, the estimation unit 3003 recognizes the category of each pixel of the input image. That is, the processing in S4004 is a forward propagation process by the CNN 103. More specifically, the CNN 104 first performs a front-stage forward propagation process, the side information is then input to the intermediate layer, and the output of the intermediate layer 106 is obtained. In this embodiment, the side map is estimated by one channel of the intermediate layer output as described above.

The side information is input as the bias of the convolutional layer, but this is merely an example, so the side information can also be used by an arbitrary method as long as a final output can be obtained by using the side information input to the intermediate layer. For example, when the side information has the same size as that of the output from the intermediate layer, the estimation unit 3003 can calculate the Bv map by multiplication of an element in the corresponding position. The estimation unit 3003 can also perform pre-processing on the side information before performing the convolutional calculation for calculating the Bv side map. In this embodiment, the estimation unit 3003 performs 1×1 convolution on the side information as pre-processing, and can further perform normalization. Assume that the weight and the bias to be used in the 1×1 convolution and parameters to be used in the normalization are learned and recorded at the time of learning.

Note that if a feature amount obtained by the front-stage forward propagation process is almost zero (for example, an entirely gray image), the final output may largely depend on the side information. Assuming a case like this, a channel to which the side information is applied as a bias is set as a part (in this embodiment, one channel) of the whole, thereby forming a channel to which the side information is not applied at all. This can reduce the dependence on the side information in a special case.

After the output including the channel 107 of the Bv map is obtained, the estimation unit 3003 inputs the Bv map to the CNN 108, and obtains the inference result 110 by performing a forward propagation process to the output layer 109. In this processing of the CNN 108, feature extraction for region category determination is performed based on both the Bv map and a feature amount extracted from pixel information of the image, and region category determination is performed in the output layer 109 by using the extracted feature amount.

The Bv map corrected by using Bv is a map reflecting the absolute value of absolute light intensity in each region on the image. Accordingly, when the inference process using Bv is performed, it is possible to perform the process of recognizing a recognition target by using both information of the appearance of the RGB image and the light intensity of each region. The processing like this can improve the accuracy of classification by referring to the side information, when classifying, for example, an outdoor cloudy sky region (Sky region, white, high Bv) and an indoor white wall surface (Other region, white, low Bv).

The foregoing is the runtime processing. Next, processing during learning will be explained with reference to the flowchart shown in FIG. 4B.

In S4101, the learning storage unit 3101 sets parameters (the weight and the bias) of each layer of the CNN. If learned parameters exist in each layer of the CNN, the learning storage unit 3101 can set the learned parameters as the parameters of the layer instead of setting any initial values. In addition, the learning storage unit 3101 sets hyper parameters for learning. Examples of the parameters to be set are parameters used in a general CNN, such as a minibatch size, a learning coefficient, and parameters of a solver in stochastic gradient descent, so a detailed explanation of the setting processes of these parameters will be omitted.

In S4102, the data acquisition unit 3102 acquires learning data. In this step, the data acquisition unit 3102 can acquire learning data from the learning storage unit 3101 that functions as a storage device. For this purpose, the learning storage unit 3101 can save an image for learning, side information, and GTs corresponding to them in association with each other. The acquisition unit 3102 can also perform a data augmentation process such as random cutting or color conversion, or pre-processing such as normalization, for each image.

In S4103, the GT formation unit 3103 forms side map GT based on the side information acquired in S4102. An example of the process of forming side map GT by using the side information Bv and a RAW image will be explained below.

The GT formation unit 3103 acquires Bv(i) for each pixel by correcting a pixel value of the RAW image by Bv based on equation (1) below:

$${L}^{( i )} = 0.25 \cdot {r}^{( i )} + 0.5 \cdot {g}^{( i )} + 0.25 \cdot {b}^{( i )} \qquad ( 1 )$$

$${Bv}^{( i )} = Bv + {log}_{2} \frac{{L}^{( i )}}{opt}$$

where i is the index of a pixel, and r⁽ⁱ⁾, g⁽ⁱ⁾, and b⁽ⁱ⁾ are pixel values of R, G, and B channels corresponding to the ith pixel of an RGB 3-channel image obtained by demosaicing the RAW image. Also, opt is a constant obtained from reference values of an image sensor, that is, the aperture value, the exposure time, and the sensitivity, and Bv⁽ⁱ⁾ is Bv of the ith pixel. The weights of r⁽ⁱ⁾, g⁽ⁱ⁾, and b⁽ⁱ⁾ are examples, so different values can also be used.

The range of Bv can freely be set. Generally, Bv has a range of about −10 to +15, has a value of about −5 in dark indoors, and has a value of about +10 in bright outdoors. By taking this into account, the GT formation unit 3103 can clip an effective Bv range in accordance with a recognition target. For example, the GT formation unit 3103 can set [0, 10] as the Bv range in order to increase the classification accuracy of Sky region (sky, cloud) and Other region (white wall, other) in the open air in the daytime. In addition, the GT formation unit 3103 forms a map having an appropriate range corresponding to an application, such as [0, 1] or [0, 4], as a side map to be learned by a channel of the intermediate layer.

The transformation method of projection from the value of Bv to the value of a map when forming a Bv map is not particularly limited, and can be selected from effective transformations. The GT formation unit 3103 can select an effective transformation method from, for example, linear transformation and non-linear transformations (a polynomial function, a sigmoid function, and a logarithmic function), can combine these transformation methods, and can perform these transformations only once or a plurality of times.

By forming the side map GT as described above, learning that increases the classification accuracy can be performed when the side information of a region sample of a given category concentrates to a specific range. In this embodiment, projection is performed on the map by linear transformation by setting the Bv range to [0, 10] and the map value range to [0, 1]. In this case, the side map GT is 0 when the Bv value is 0 or less, and is 1 when the Bv value is 10.

In S4104, the estimation unit 3104 recognizes the category of an image in the minibatch by the forward propagation process by the CNN 203. Since this processing is performed in the same manner as the processing in S4004, a repetitive explanation thereof will be omitted.

In S4105, the loss calculation unit 3105 calculates a loss based on a predetermined loss function, from the output of forward propagation as a learning target of the CNN 203 and the corresponding GT. As the output of forward propagation, the loss calculation unit 3105 uses the output 210 (to be appropriately called “response” hereinafter) of one channel of the intermediate layer 206, and the final network output 202. GT corresponding to the output 210 is the side map GT 212, and GT corresponding to the output 202 is the GT 102 of each category. The output 202 is 3-channel output corresponding to Plant, Sky, and Other, and GT of each category corresponding to that is also 3-channel data. The number of channels of the side map GT 212 is 1, that is, the same as the Bv map and the output 210. In this embodiment, the loss calculation unit 3105 calculates a cross-entropy loss for each of specific domain GT and each category GT from the pair of these outputs and GTs, and sums up the two calculated cross-entropy losses while properly weighting them. The influence on recognition by the side information can be increased by increasing the weight on the side map GT, and the user can freely set this weight.

In S4106, the updating unit 3106 updates parameters of the CNN. In this embodiment, the updating unit 3106 calculates the weight of each layer of the CNN and the update amount of the bias with respect to the whole loss calculated in S4105, and updates them. The dictionary storage unit 3107 stores the values of the updated weight and bias.

S4102 to S4106 are loop processing (L4001), and repeated until the loss calculated in S4105 sufficiently converges. In this processing, a threshold to be used to determine whether the loss has sufficiently converged is set at a desired value in advance, and whether the loss is equal to or smaller than this threshold is determined. If it is determined that the loss has sufficiently converged, the loop processing is terminated; if not, the process returns to step S4102.

In this process as described above, an RGB image is input to the CNN, and the side information (Bv) is input to the intermediate layer. Therefore, learning can be performed so as to estimate a Bv map by a given output channel of the intermediate layer. This makes it possible to implement inference using the side information inside the CNN with a calculation cost lower than that when both an RGB image and the Bv map are input from the input layer of the CNN.

Note that this embodiment has been explained by assuming that the image recognition process is performed by semantic segmentation, but the type of image recognition process is not limited to this. For example, as a recognition task similar to semantic segmentation, it is also possible to perform an image recognition process that estimates, in each pixel of an output map, the ratio of a region label within a block of a corresponding input image. In this case, the resolution of the output map is smaller than that of the input image, one pixel of the output map corresponds to a block including a plurality of pixels in the input image, and the ratio of the region label is the ratio of region label pixels in the block. For example, when a VGA image (640×480) is input and an 80× 60 map is output, one pixel of the output map corresponds to a block including 8×8 pixels of the input image, and the ratio of a region label is the ratio of region label pixels in this 8×8 block. For example, when 32 pixels in a block of an input image corresponding to a given output pixel are category Sky, the Sky ratio of the output pixel is 0.5.

In addition, the learning apparatus 3100 according to this embodiment can also use, for example, a well-known image classification technique or object detection technique, instead of semantic segmentation or a similar task, and can perform learning similarly using side information by evaluating the accuracy of image recognition by setting appropriate evaluation indices. When using the object detection technique, after a map of the final inference result 110 is output, post-processing such as coordinate recurrence by a fully connected layer or non-maximum suppression is performed. Even in a case like this, it is similarly possible to perform the process of performing learning so as to estimate a side map by a predetermined channel of the intermediate layer. Accordingly, even when using different recognition tasks, the recognition accuracy can be improved with a low calculation cost by inputting side information to the intermediate layer and performing inference based on the side information by the output from the intermediate layer of the CNN.

### Second Embodiment

The recognition apparatus and the learning apparatus according to the first embodiment use Bv as side information and perform learning such that one channel of an intermediate layer of a CNN estimates a Bv map, thereby realizing, with a low calculation cost, an effect similar to that when inputting an RGB-Bv image to an input layer. GT for use in the learning of the Bv map estimation can be formed by a formation method previously set by taking account of the characteristic of a recognition target. Optimum selection of a parameter to be used in the formation of the side map GT may change in accordance with the characteristic or state of a recognition target. In consideration of this, an information processing apparatus according to this embodiment prepares verification data, and searches for (by, for example, grid search) a parameter to be used to form a side map GT so that the estimation accuracy is optimized with respect to the verification data. A network configuration for use in a recognition process and learning process of a CNN according to this embodiment is the same as that of the first embodiment, so a repetitive explanation thereof will be omitted.

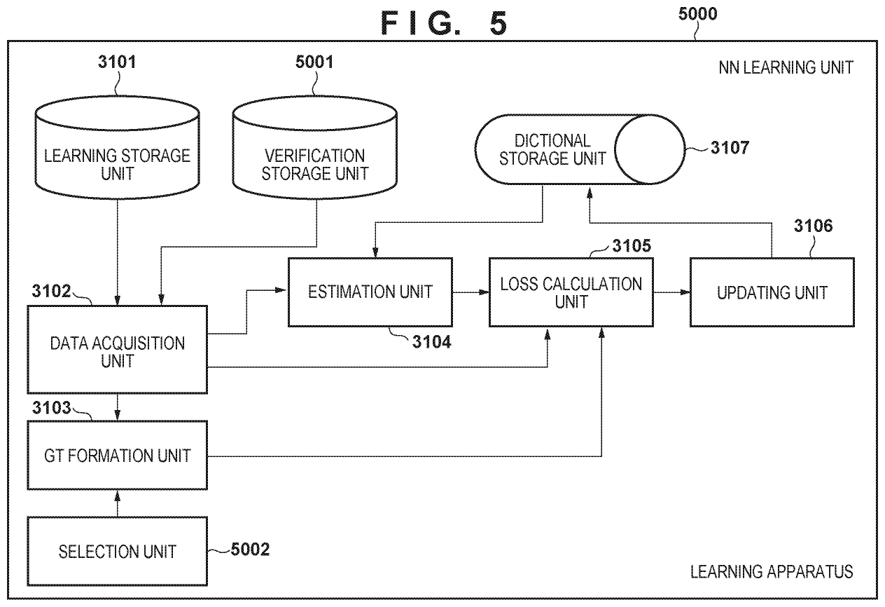

FIG. 5 is a block diagram showing an example of the functional configuration of a learning apparatus 5000 according to this embodiment. The learning apparatus 5000 has the same configuration as that of the learning apparatus 3100 of the first embodiment, except that a verification storage unit 5001 and a selection unit 5002 are additionally installed.

FIG. 4C is a flowchart showing an example of a parameter selection process to be performed in addition to the process shown in FIG. 4B, in the learning process according to this embodiment. In this process shown in FIG. 4C, a parameter to be used when forming a side map GT is selected by performing grid search loop processing.

In S4201, the selection unit 5002 selects one parameter relating to the formation of a side map GT as a use parameter. In this step, the selection unit 5002 can select the use parameter from parameters having types and a range determined by the search space of grid search. In this embodiment, a parameter is selected by using, as the search space, the lower or upper limit of Bv, the lower or upper limit of a map, a projecting function (linear or a sigmoid function), positive/negative (a positive map or a negative map), or learning ON/OFF of each output channel of an intermediate layer. The learning ON/OFF of each output channel of an intermediate layer is setting for switching whether to perform side map learning with respect to each output channel of the intermediate layer for which learning is performed to output a side map. This learning ON/OFF can be either discrete switching setting as described above or continuous setting. An example of the continuous setting is to set the reflection rate of a side map by a real number [0, 1] for each output channel, and perform the setting such that the learning rate of the side map increases as the reflection rate approaches 1.

The selection unit 5002 need not search the whole search space described above, that is, can perform selection for only some parameters, and can also set a different search range. For example, the selection unit 5002 can fix one channel of output channels of the intermediate layer for outputting a side map, fix a projecting function to a linear function, fix the range of the map to [0, 4], and select other parameters. In this case, the speed of the selection process is increased because the search space is narrowed to three dimensions (the lower limit of Bv, the upper limit of Bv, and positive/negative). In the process in S4201, the selection unit 5002 selects a parameter corresponding to the grid of the search space as a parameter to be used when forming GT.

In S4202, the learning apparatus 5000 executes learning of the CNN by using the use parameter selected in S4201. This learning process performed in S4202 is performed in the same manner as in the flowchart shown in FIG. 4B except that the parameter selected in S4201 is used as the use parameter.

In S4203, the selection unit 5002 evaluates the accuracy of recognition of a recognition target by the CNN learned in S4202 by using verification data. For example, the selection unit 5002 can calculate an error in an output by using an input image contained in the verification data and GT of the image, and can evaluate the recognition accuracy by using the sum total of the errors calculated from the verification data as an index. For this purpose, the verification storage unit 5001 can store a plurality of sets of an image to be input to the CNN and GT of an output image as the verification data.

In S4204, the selection unit 5002 determines whether the selection of the use parameter is complete. In this step, the selection unit 5002 can determine whether the selection is complete, in accordance with whether all grids in the search space are processed. If the selection is complete, the process is terminated; if not, the process is returned to S4201.

If the process is complete in S4204, the selection unit 5002 can compare the recognition accuracies evaluated in S4203 for the individual parameters, specify a use parameter having the highest recognition accuracy, and select this use parameter as a final use parameter. When using the specified parameter in runtime processing, a recognition process using an optimum parameter can be performed.

Note that an example of performing optimization by using grid search is explained in this embodiment, but the present invention is not limited to this method as long as a use parameter can be optimized, and a well-known arbitrary method can be used. For example, the selection unit 5002 can use a different method that performs optimization by using a search space, such as a genetic algorithm or a simplex method, instead of grid search.

### Third Embodiment

The first embodiment has been explained by assuming that the side information is basically a scalar value, but the side information is not limited to a scalar value. In this embodiment, processing to be performed when the side information is not a scalar value will be explained in detail below.

The side information can be either a one-dimensional vector or a two-dimensional vector. When the side information is a two-dimensional vector map, the resolution can be lower than that of an input image. It is also possible to prepare a side map GT from each of a plurality of side information, and simultaneously estimate corresponding side maps in an intermediate layer. A depth map as the side information need not have a resolution lower than that of an original image, and can also be, for example, information (a scalar value) of a distance to an in-focus subject measured by using a focusing sensor of a single lens reflex camera.

In this embodiment, an example in which a subject distance is used together with Bv as the side information will be explained. In this example, a depth map having a resolution lower than that of an input image is set as information indicating the subject distance, and a recognition apparatus estimates a depth map having the same resolution as that of the input image as a side map, thereby using the depth map in region category discrimination.

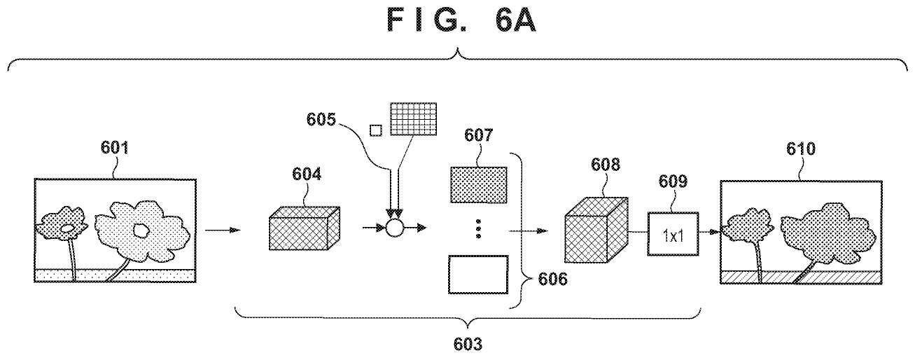

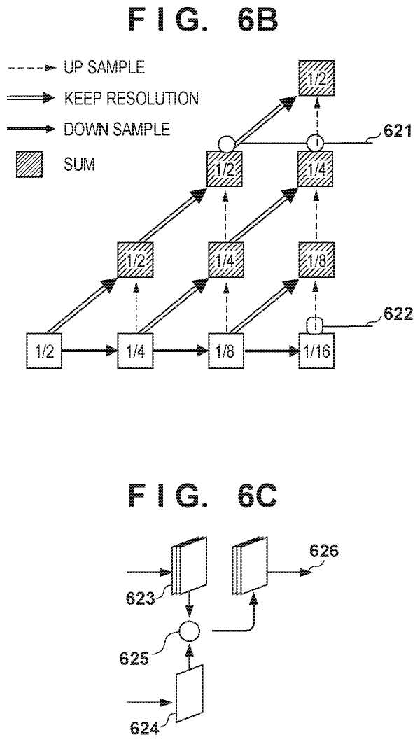

FIG. 6A is a schematic view of a network for explaining the recognition process to be performed by the recognition apparatus according to this embodiment. The basic recognition process can be performed in the same manner as that shown in FIG. 1C, so a repetitive explanation thereof will be omitted.

A CNN 603 shown in FIG. 6A includes a CNN 604, an input terminal 605, an intermediate layer 606, a CNN 609, and an output layer 610. In this example, the same processing as that shown in FIG. 1C is performed except that Bv and a depth map (subject distance) are input to the input terminal 605, and a Bv map and a depth map are estimated in an output channel 608 of the intermediate layer 606.

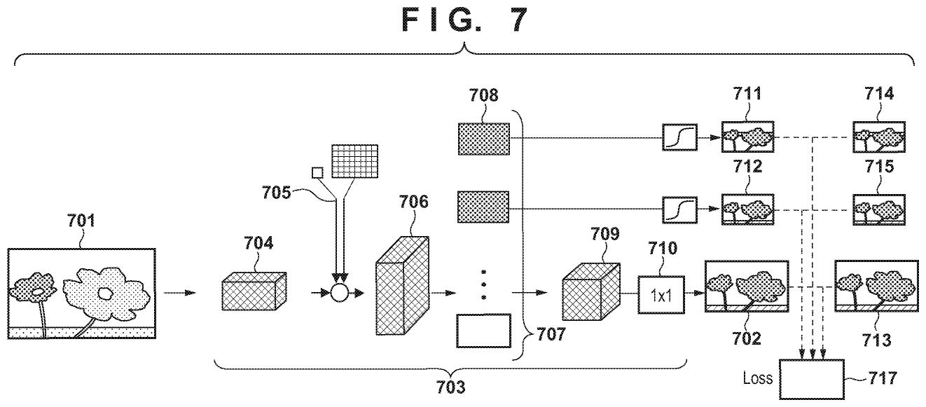

FIG. 7 is a view showing an example of the network configuration of a CNN when performing learning according to this embodiment. Referring to FIG. 7, in addition to the network configuration shown in FIG. 2, a depth map is additionally input as side information to an input terminal 705 (corresponding to the input terminal 205), and this depth map and a Bv map are estimated as side maps 708 in an output 707 of an intermediate layer 706. Also, errors between outputs 711 and 712 from activation layers of the side maps 708 and GTs 714 and 715 of the outputs 711 and 712 are calculated, and a final learning process is performed by using an error between the output from a final activation layer 710 and GT 713 as well. That is, the output 712 corresponding to the depth map and the depth map GT 715 are added to the configuration shown in FIG. 2.

The recognition process to be performed by the recognition apparatus 3000 according to this embodiment is basically performed in the same manner as that shown in FIG. 4A of the first embodiment. The difference from the processing in the first embodiment will be explained with reference to FIG. 4A. The processes in S4001 and S4002 are performed in the same manner as in the first embodiment.

In S4003, a side acquisition unit 3002 acquires side information. In this embodiment, the side acquisition unit 3002 acquires a plurality of pieces of side information (in this example, Bv and a subject distance). Bv is acquired as a scalar value, and a depth map indicating the subject distance is acquired as a two-dimensional vector.

A method by which the side acquisition unit 3002 acquires the depth map will be explained below. The side acquisition unit 3002 can acquire a subject distance as a depth map by using, for example, contrast AF (AutoFocus). When using an inexpensive digital still camera not including a focusing sensor such as a compact camera, automatic focusing is sometimes performed by measuring a contrast value that changes in synchronism with the position of a focusing lens, and searching for the peak of the contrast value. In this embodiment, automatic focusing like this will be called contrast AF. In this contrast AF, a contrast value is measured in each block on an image, and a peak is searched for by moving the focusing lens in a direction in which the contrast value increases (also called a mountain-climbing method). When the peak of the contrast value is found, the search is terminated.

As another example, the side acquisition unit 3002 can acquire a subject distance as a depth map by using image plane phase difference AF. The image plane phase difference AF is AF that performs automatic focusing by using a shift amount of focusing detected by phase difference detecting elements sparsely arranged on an image sensor. This shift amount of focusing can be converted into a distance, so a sparse depth map can be acquired. The image plane phase difference AF is performed in an interchangeable lens camera such as a single lens reflex camera or a mirrorless camera. They are merely examples, and another well-known method can also be used as the method of acquiring a depth map.

In S4004, the estimation unit 3003 recognizes a recognition target in input data by using a machine learning model having a hierarchical structure including a plurality of layers. In the processing in S4004 according to this embodiment, as described above, a depth map is input to the intermediate layer as the side information in addition to Bv, and a side map is estimated for each side information.

FIG. 6B is a view showing an example of a network structure that repetitively aggregates high-dimensional features into low-dimensional features. The CNN 604, the input terminal 605, the intermediate layer 606, and the channel 608 configuring the CNN 603 according to this embodiment can also have a configuration shown in FIG. 6B. This configuration is used in, for example, Fisher Yu, Dequan Wang, Evan Shelhamer, and Trevor Darrell, “Deep Layer Aggregation”, and can obtain a feature map with a higher solution.

“Down sample” shown in FIG. 6B is a process of decreasing the resolution by pooling or the like. “Up sample” is a process of increasing the resolution by bilinear interpolation or the like, and “Keep resolution” is a process of keeping the resolution unchanged. “Sum” represents the sum of feature amounts for each element of a map. In FIG. 6B, 621 represents input of side information as a scalar value or a one-dimensional vector. When the side information is a scalar value or a one-dimensional vector, the side information is processed by using the weight and the bias in the same manner as in the first embodiment, and input to a feature amount map of the intermediate layer. When the side information is a one-dimensional vector, the weight is a matrix (input dimension×feature amount dimension), and the bias is a vector of the feature amount dimension. When performing CNN learning, learning is performed on these weight and bias in the same manner as for other CNN parameters.

622 represents input of side information as a low-resolution, two-dimensional map. In 622, side information as a two-dimensional vector is input with respect to a feature amount map having a resolution down-sampled to 1/16. FIG. 6C is a view for explaining an example of inputting this side information as a two-dimensional vector. 623 is the feature amount map having a resolution that is 1/16 of the original resolution of an image. 624 is the side information as a two-dimensional vector, and 625 represents an arithmetic operation of connecting 623 and 624. As this arithmetic operation for connection, a process of adding or multiplying, to a specific channel of the feature amount map, an element in the corresponding position of the side information is performed. As the arithmetic operation for connection, a process of connecting the side information in a channel direction of the feature amount map may also be performed. Like the side information in the first embodiment, pre-processing such as processing using the weight or the bias or a normalization process can be performed in advance for the side information as a two-dimensional vector. 626 is a feature amount map after the abovementioned connecting process.

By the process as described above, a side map is estimated by the output from a specific channel of an intermediate layer 607 of the CNN 603.

In S4004, the estimation unit 3003 determines a region category as a final task based on the pixel information of the image, and the image feature amount derived from the Bv map and the depth map. In an image in which a white wall surface (Other) exists at a close distance from the camera and a white cloudy sky (Sky) exists in the background, the depth map shows that the wall surface exists in the vicinity and the cloudy sky exists at infinity. Since learning is performed by using the depth map by taking account of a case like this, it is possible to improve the classification accuracy of recognition targets having similar features indicated by pixel information but having different subject distances. Furthermore, since learning is performed by using the Bv map in addition to the depth map, it is possible to improve the classification accuracy by further using the light intensity in each region as a criterion.

The foregoing is the runtime processing. Next, processing during learning will be explained. The processing during learning is basically the same as the processing shown in FIG. 4B of the first embodiment, so a repetitive explanation will be omitted.

In S4102 and S4103 according to this embodiment, a side map GT is formed as in the first embodiment. In this example, a side map GT is formed for each of Bv and the subject distance. As GT of a depth map, it is possible to prepare a depth map having a high resolution (higher than that of side information), close to some extent to the resolution of an input image. This high-resolution depth map can be obtained by an arbitrary method such as a stereo method or a method using a TOF sensor.

By performing a learning process by using the side map GTs as described above, it is possible to perform CNN learning that performs a final recognition task by inputting a feature amount map acquired by the CNN from an input image, and inputting a two-dimensional depth map having a low resolution (lower than that of the original image).

Note that the side information is not limited to Bv or the subject distance as described above. For example, a defocus map (a map of a defocus amount) can be estimated as a side map by using one or both of the aperture value and the focal length (a one-dimensional vector) of the lens as side information. GT of the defocus map can be acquired by using, for example, an image plane phase difference AF camera in which phase difference detecting elements are densely arranged. By performing learning so as to estimate the defocus map in the intermediate layer, the recognition accuracy can be improved by taking account of a defocus amount in each region as well. Accordingly, an effect is expected in a case in which the features of pixels are similar but the defocus amounts thereof are different, such as classification of a green plant leaf (Plant, a large defocus amount) defocused by macro image capturing, and a flat green artifact (Other, a small defocus amount).

As another example, an RGB value before application of white balance processing can be estimated as the side map by using the coefficient (WB coefficient) of the white balance processing as the side information. This can be realized by performing learning such that the intermediate layer 606 recalculates the RGB value before application of the white balance processing in each region based on the feature amount of a pixel extracted by the CNN 604 and the WB coefficient. In this configuration, the recognition process can be performed based on both the pixel value of an input image in which the influence of the illumination color is reduced by the white balance processing, and the RGB value before application of the white balance processing, that is, the pixel value strongly influenced by the illumination color. Therefore, even in an image converted into an abnormal color by performing the white balance processing so as to remove the tone of a light source color by mistake, it is possible to reduce the possibility that region category discrimination fails.

### Fourth Embodiment

The first to third embodiments have been explained by assuming that an image input to a CNN is one still image. In this embodiment, an explanation will be made by assuming a case in which a recognition target in a moving image including a plurality of temporally continuous images is tracked.

A recognition apparatus and a learning apparatus according to this embodiment can perform, for example, the processes shown in FIGS. 4A and 4B in the same manner as in the first embodiment, with respect to each of a plurality of images input to a CNN. As side information according to this embodiment, a motion vector formed by motion compensation in video compression can be used. An explanation will be made by assuming that a motion vector is used as side information and an optical flow is used as a side map.

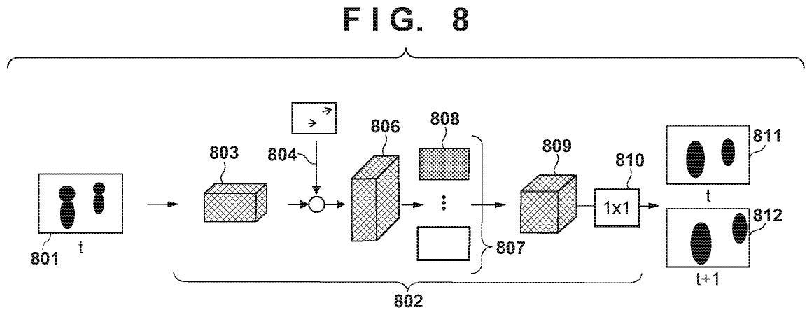

FIG. 8 is a view for explaining a recognition process to be performed by the recognition apparatus according to this embodiment. In this example shown in FIG. 8, a frame (image) at time t is input from a moving image to a CNN 802, and the CNN 802 outputs a heat map indicating the existence probability in each position of a tracking target at that time, and the bounding box size of the tracking target. At the same time, the CNN 802 outputs a heat map indicating the existence probability in each position of the tracking target at time t+1 following time t, and the bounding box size of the tracking target.

An input image 801 shown in FIG. 8 is a frame at time t contained in the moving image. The CNN 802 includes a CNN 803, an input terminal for receiving a motion vector, an intermediate layer 806, a CNN 809, and an output layer 810, and has the same basic network configuration as that shown in FIG. 1C or 6A except parameters. In this embodiment, a convolutional layer having recursive connection can be used in the CNN 803, the intermediate layer 806, and the CNN 809. In this case, past time-series information is converted into a feature amount and reflected on tracking and estimation processes, so it can be expected that the estimation accuracy of an optical flow improves.

Side information 804 in the example shown in FIG. 8 is a motion vector. For this motion vector, a block size for performing motion estimation can be set to an arbitrary size (for example, 16×16 or 8×8), but the setting varies in accordance with the compression method or the compression rate of a moving image. When inputting to the input terminal, the side information 804 is appropriately resized, and a motion vector having a uniform resolution is input to the CNN 802. Note that in this embodiment, a motion vector in one frame at time t is so set that it is estimated by using an image at time t and an image at time t−1 temporally continuous to time t. However, the present invention is not particularly limited to this processing as long as a motion vector corresponding to each time can be set. For example, a motion vector estimated from an image at time t and an image at time t+1 can also be set as a motion vector at time t.

807 is an output channel of the intermediate layer 806, and 808 is a side map. In this example shown in FIG. 8, the side map 808 is an optical flow and has a resolution higher than that of the motion vector. Also, a recognition apparatus 9000 according to this embodiment has learned to estimate optical flows at time t and time t+1 as GTs by using motion vectors of images at time t and time t−1. A configuration like this can provide a recognition apparatus having learned to predict a future motion by using side information.

The CNN 809 receives an output from each channel of the intermediate layer 806, and outputs information for estimating and predicting the above-described heat map and bounding box size. The output layer 810 includes a 1×1 convolutional layer having a necessary number of output channels and an activation layer, and supplies outputs 811 and 812.

The outputs 811 and 812 respectively correspond to time t and time t+1. Each of the outputs 811 and 812 contains a heat map, and a map indicating an estimation value of the size of a bounding box in each of two directions, that is, the X-axis direction and the Y-axis direction, at the corresponding time. That is, each of these outputs is supplied as a 3-channel map with respect to the corresponding time.

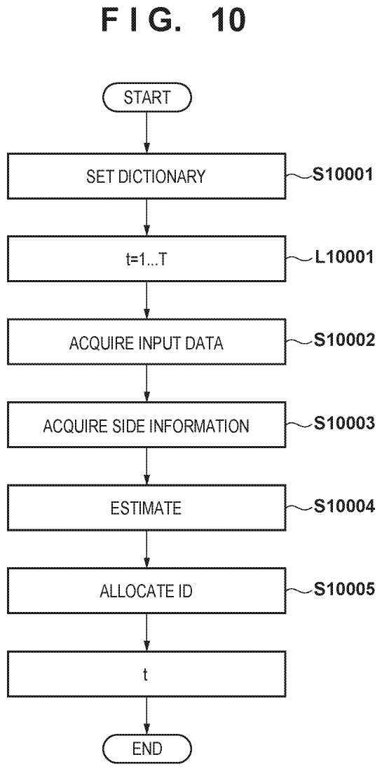

In this example, a peak is detected by performing post-processing such as NMS on the heat map, and the peak position is set as the central position of the bounding box. Then, the size (in this example, the width and the height) of the bounding box is acquired by reading a value near the peak position from the map of the bounding box size. The processing like this determines the coordinates (X, Y) of the bounding box indicating a tracking target, and the width and height of the bounding box. In the tracking process according to this embodiment, an ID is allocated to each tracking target. This process will be described later as runtime processing with reference to a flowchart shown in FIG. 10.

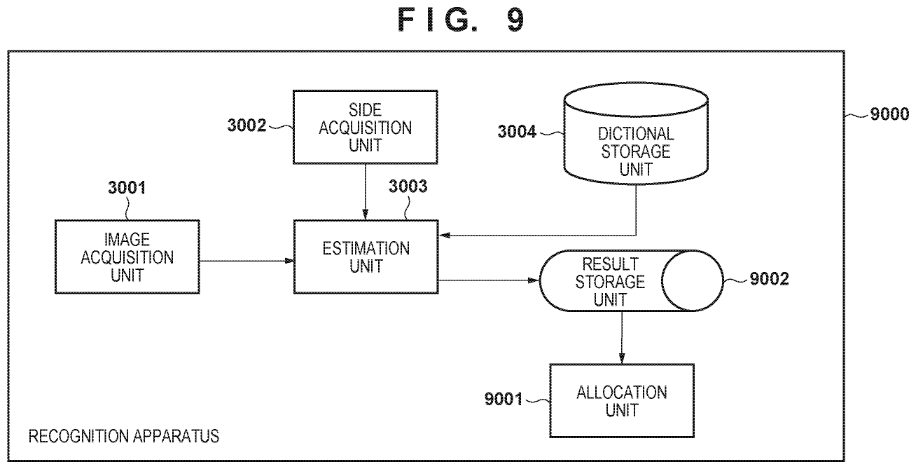

FIG. 9 is a block diagram showing an example of the functional configuration of the recognition apparatus 9000 according to this embodiment. The recognition apparatus 9000 has the same configuration as that of the recognition apparatus 3000 shown in FIG. 3A except that an allocation unit 9001 and a result storage unit 9002 are additionally installed, so a repetitive explanation will be omitted. Processes to be performed by these functional units will be explained with reference to the flowchart shown in FIG. 10.

FIG. 10 is a flowchart showing an example of the process to be performed at runtime by the recognition apparatus 9000 according to this embodiment. In S10001, a dictional storage unit 3004 sets a dictionary to be used by an estimation unit 3003 in the same manner as in S4001 of the first embodiment. In S10002, an image acquisition unit 3001 acquires an image as a target of the recognition process in the same manner as in S4002. In this example, an image at given time t (1≤t≤T) is acquired.

In S10003, a side acquisition unit 3002 acquires a motion vector as side information. As described above, this motion vector has a resolution lower than that of the image acquired in S10002, and is resized to a size appropriate as an input to the intermediate layer of the CNN. Also, with respect to the image at time t, the motion vector is calculated from frame images at times t−1 and t.

In S10004, the estimation unit 3003 estimates and recognizes a recognition target in the input data in the same manner as the processing in S4004. In this step, the estimation unit 3003 estimates an optical flow calculated from the images at times t and t+1 in the output from the intermediate layer, and outputs the heat map and a map of the bounding size box at times t and t+1. In addition, the estimation unit 3003 determines the parameters (the center coordinates (X, Y), the width, and the height) of the bounding box explained in FIG. 8 for each tracking target, and stores the determination results in the result storage unit 9002.

In S10005, the allocation unit 9001 allocates a person ID to each tracking target. First, the allocation unit 9001 reads out the estimation result of the bounding box at an immediately preceding time from the result storage unit 9002, and forms an affinity matrix between this estimation result and the estimation result of the bounding box at the current time. The affinity of the estimation result to be evaluated can be, for example, Intersection over Union (IoU) or the Euclidean distance of the parameter of the bounding box, and can be calculated by an arbitrary evaluation method. IoU is an evaluation index representing the overlap of bounding boxes. The affinity increases as the index approaches 1, and decreases as the index approaches 0. In this embodiment, IoU will be called a score matrix. The Euclidean distance is a value that decreases as the affinity increases, and increases as the affinity decreases. In this embodiment, the Euclidean distance will be called a cost matrix.

When the number of detection targets is m at time t and the number of detection targets is n at time t−1, a matrix of n×m is obtained by simply forming an affinity matrix. In this example, however, the calculation is performed by assuming that the matrix is a square matrix matching a larger one of n and m. In this square matrix, 0 is allocated to an element originally having no value when using the score matrix, and a sufficiently large value is allocated to the element when using the cost matrix.

ID allocation is performed by using the algorithm of an appropriate allocation problem. In this example, the allocation unit 9001 can allocate IDs by using the Hungarian algorithm. The allocation unit 9001 obtains allocation that maximizes the score when using the score matrix, and obtains allocation that minimizes the cost when using the cost matrix.

S10002 to S10005 are loop processing (L10001), and repeated until the processing is completely performed on all of time t=1, . . . , T. When the processing is completely performed on all times, the process is terminated; if not, the process returns to S10002. The process like this can perform person tracking at times 1 to T of a moving image.

In this embodiment, the heat map and the bounding box size are prepared in addition to the optical flow as GTs to be used in learning of the CNN. GT of the optical flow can be formed from a moving image by using an arbitrary well-known method that estimates the optical flow. For example, it is possible to use a method of generating a dense optical flow having a high calculation load, such as dual TV-L1.

In this embodiment, GT of the heat map is a map formed by a 2-variable Gaussian function by which the center of a human body is a peak and the value of the peak position is 1.0. GT (two channels) of the bounding box size is a map in which a value near the peak position indicates the height or width of the bounding box, and other values are 0. In this case, the center of the bounding box matches the peak position of the heat map.

Note that the peak position of the heat map need only be a position that is convenient for performing annotation of GT, that is, need not be the center of a human body. For example, the peak position can also be the position of the waist or the position of the center of the head. When the peak position of the heat map is not the center of a human body, it is also possible to additionally prepare GT of the central position of the bounding box and perform learning. That is, it is also possible to add a map of two channels of bounding box center offset (the X-axis direction, the Y-axis direction) as GT and a side map, and perform learning such that the CNN outputs a map of a total of five channels at each time. Learning is performed on the bounding box center offset such that the offset value from that position to the bounding box center is output. That is, GT of the bounding box center offset is a map of two channels in which a portion near the peak position of the heat map is a vector from a specific position on a human body to the bounding box center, and other values are zero.

In a configuration like this, it is possible to estimate an optical flow at the next time and estimate the bounding boxes of tracking targets at the current time and the next time by using a motion vector as the side information. In addition, a target tracking process can be performed by allocating an ID to the bounding box. Furthermore, since the CNN estimates a dense optical flow based on a sparse optical flow, the calculation cost can be made lower than that of the process of calculating an existing dense optical flow.

Note that in this embodiment, learning is so performed that GT of the optical flow is formed by using frames at time t and time t+1, and heat maps at time t and time t+1 are estimated as the output from the CNN. A configuration like this can decrease the latency of the runtime processing and increase the real-time property. However, different processing can also be performed if the real-time property is unnecessary. For example, learning can also be performed such that GT of the optical flow is formed by using frames at time t−1 and time t, and heat maps at time t−1 and time t are estimated as the output from the CNN. In this case, at least a latency of one frame is generated.

### Fifth Embodiment

In the above-described embodiments, the processing units shown in, for example, FIGS. 3A and 3B can also be implemented by dedicated hardware. Alternatively, some or all processing units of the recognition apparatus (for example, 3000) and the learning apparatus (for example, 3100) can also be implemented by a computer. In this embodiment, a computer executes at least some of the processes according to the above-described embodiments.

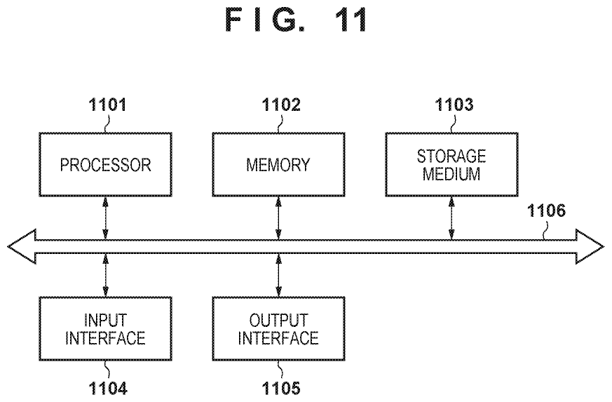

FIG. 11 is a view showing the basic configuration of the computer. Referring to FIG. 11, a processor 1101 is, for example, a CPU, and controls the operation of the whole computer. A memory 1102 is, for example, a RAM, and temporarily stores programs, data, and the like. A computer-readable storage medium 1103 is a hard disk, a CD-ROM, or the like, and stores programs, data, and the like for a long time period. In this embodiment, a program that is stored in the storage medium 1103 and implements the function of each unit is read out to the memory 1102. Then, the processor 1101 operates in accordance with the program on the memory 1102, thereby implementing the function of the unit.

In FIG. 11, an input interface 1104 is an interface for acquiring information from an external apparatus. An output interface 1105 is an interface for outputting information to an external apparatus. A bus 1106 connects the above-described units and exchanges data.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-145065, filed Sep. 6, 2021, which is hereby incorporated by reference herein in its entirety.

1.-20. (canceled)

21. An information processing apparatus comprising:
a processor; and
a memory storing instructions which, when executed by the processor, cause the processor to:
perform, using a convolutional neural network, image recognition on a recognition target in a captured image based on pixel information of the captured image and information relating to the captured image other than the pixel information;
input the pixel information to a first portion of the convolutional neural network; and
input, to a second portion of the convolutional neural network subsequent to the first portion, correction information obtained by correcting an output of the first portion using the information relating to the captured image,
wherein the image recognition comprises classifying a partial region in the captured image into a plurality of categories including at least a category corresponding to a plant or a sky.

22. The apparatus according to claim 21, wherein
the convolutional neural network includes an intermediate layer between the first portion and the second portion, and
the information relating to the captured image other than the pixel information is used in a convolutional calculation in the intermediate layer.

23. The apparatus according to claim 22, wherein the information relating to the captured image other than the pixel information is used in a convolution operation in one or more channels of the intermediate layer.

24. The apparatus according to claim 22, wherein the information relating to the captured image other than the pixel information is used as a bias in the intermediate layer, multiplied by the output of the first portion for each element, or connected to the output of the first portion in a channel direction.

25. The apparatus according to claim 22, wherein before being used in the convolution operation in the intermediate layer, the information relating to the captured image other than the pixel information undergoes a process of multiplying the information by a previously learned weight, a process of adding a previously learned bias to the information, or a process of normalizing the information by a previously learned parameter.

26. The apparatus according to claim 21, wherein the information relating to the captured image other than the pixel information is a scalar value, a one-dimensional vector, or a two-dimensional vector.

27. The apparatus according to claim 21, wherein the information relating to the captured image other than the pixel information is calculated from an image capturing parameter of an image capturing device that captures the captured image, or from the pixel information.

28. The apparatus according to claim 27, wherein the information relating to the captured image other than the pixel information is a coefficient of white balance processing, an aperture value, a focal length, an evaluation value of automatic exposure, an evaluation value of a subject distance, or a motion vector.

29. The apparatus according to claim 21, wherein
the captured image is one of a plurality of temporally continuous images, and
wherein the instructions, when executed by the processor, further cause the information processing apparatus to:
track a recognition target in the plurality of images, as the image recognition.

30. The apparatus according to claim 21, wherein the number of dimensions of the information relating to the captured image other than the pixel information is smaller than that of the pixel information, and the number of dimensions of the correction information is larger than that of the information relating to the captured image other than the pixel information.

31. The apparatus according to claim 21, wherein learning is performed on the convolutional neural network by using ground truth data representing ground truth of the correction information, with respect to a parameter used when the output of the first portion is corrected.

32. An information processing method which performs a process according to an information processing apparatus including a convolutional neural network configured to perform an image recognition on a recognition target in a captured image, based on pixel information of the captured image, and information relating to the captured image other than the pixel information, comprising:
inputting the pixel information to a first portion of the convolutional neural network;
inputting, to a second portion of the convolutional neural network subsequent to the first portion, correction information obtained by correcting an output of the first portion using information relating to the captured image other than the pixel information; and
performing, using the convolutional neural network, image recognition on a recognition target in the captured image based on the pixel information and the information relating to the captured image other than the pixel information, wherein the image recognition comprises classifying a partial region in the captured image into a plurality of categories including at least a category corresponding to a plant or a sky.

33. A non-transitory computer-readable storage medium storing a program that, when executed by a computer, causes the computer to perform an information processing method of claim 32.
